(19) United States
(12) Patent Application Publication
(10) Pub. No.: US 2025/0249509 A1
(43) Pub. Date: Aug. 7, 2025

(54) ADDITIVE MANUFACTURING SYSTEM AND ADDITIVE MANUFACTURING METHOD

(71) Applicant: AIRBUS (BEIJING) ENGINEERING CENTRE COMPANY LIMITED, Beijing (CN)

(72) Inventors: Wenchao JIANG, Bristol (GB); Xiaolong REN, Bristol (GB); Dan DENG, Bristol (GB); Li GUO, Bristol (GB)

(21) Appl. No.: 19/046,065

(22) Filed: Feb. 5, 2025

(30) Foreign Application Priority Data
Feb. 6, 2024 (CN) 202410171640.2

(51) Int. Cl. B22F 10/50; B22F 10/28; B22F 10/36; B22F 10/38; B22F 10/85; B22F 12/50; B22F 12/90; B33Y 10/00; B33Y 30/00; B33Y 50/02

(52) U.S. Cl. CPC B22F 10/50; B22F 10/28; B22F 10/36; B22F 10/385; B22F 10/85; B22F 12/50; B22F 12/90; B33Y 10/00; B33Y 30/00; B33Y 50/02; B22F 2202/06; B22F 2301/205; B22F 2998/10

(57) ABSTRACT

An additive manufacturing system and an additive manufacturing method are disclosed including a powder supply device, configured to supply a powder material; a forming device, configured to accommodate the powder material from the powder supply device, and provide a space for printing the powder material into a workpiece; an energy source, configured to selectively apply an energy beam to the powder material in the forming device to print the powder material; and a Coulomb force application device, configured to apply a Coulomb force to the powder material in the forming device in a predetermined direction. The Coulomb force can be selectively applied to the powder material by the Coulomb force application device to provide a controlled vector force, thereby improving the industrial applicability of the additive manufacturing system and method.

### CROSS RELATED APPLICATION

This application claims priority to Chinese Patent Application CN 202410171640.2, filed Feb. 6, 2024, the entire contents of which is hereby incorporated by reference.

### FIELD

The present application relates to the technical field of additive layer manufacturing, and in particular to an additive manufacturing system and an additive manufacturing method for performing additive layer manufacturing by melting and stacking a material layer by layer.

### BACKGROUND

Additive layer manufacturing (ALM) technology is a technology in which a product is first designed by using a computer and then is printed out by using a printer. In design by using the computer, a model is established for a product to be formed, and the model of the workpiece of the product is stored in the computer for subsequent printing. During printing, a material is accumulated and printed (i.e., melted and stacked) layer by layer by using an energy source (for example, a laser beam, an electron beam, a plasma beam or an ion beam), until a final 3D product is formed. Additive layer manufacturing is commonly referred to as 3D printing. Additive layer manufacturing is particularly applicable to manufacturing a metal part with a complex shape or a special structure in aerospace industry, for example.

In the process of additive manufacturing, the material is deposited layer by layer, and the subsequent material layer needs to be deposited on the previously formed material layer. When the workpiece to be printed has a hanging structure inclined relative to a horizontal direction, if an inclination angle is greater than a critical angle (generally 45°), it can be self-supported by the formed powder material, thus forming the required hanging structure. In addition, if the inclination angle of the hanging structure to be printed is less than the critical angle of the material, the solid powder material in the lower layer cannot provide enough supporting force for the heated and melted powder droplets, leading to easy collapse or deformation of the processed workpiece, which seriously affects the quality of the processed workpiece.

In order to solve the above problems, in the existing additive manufacturing technology, the supporting structure is generally printed while printing the hanging structure, and the supporting structure provides the supporting force for this hanging structure. However, printing this supporting structure needs to consume a lot of resources, such as raw materials, printing time and energy. Moreover, after printing is completed, post-processing is needed to remove the supporting structure, which leads to poor surface quality between the supporting structure and the workpiece, reduced printing efficiency and long post-processing time.

In addition, in the existing additive manufacturing system, the printed material layer is deposited on the printed material layer by using gravity. However, the existing additive manufacturing system cannot work normally in reduced-gravity environments (for example in micro-gravity or zero-gravity environments).

### SUMMARY

An object according to the present application is to reduce the application limitation of an additive manufacturing system and method and improve the industrial applicability of the additive manufacturing system and method.

Another object according to the present application is to provide an additive manufacturing system and method which can reduce processing cost, reduce processing time and improve processing quality.

Another object according to the present application is to provide an additive manufacturing system and method that can be used in reduced-gravity environments.

According to an aspect of the present application, an additive manufacturing system is provided. The additive manufacturing system includes: a powder supply device, configured to supply a powder material; a forming device, configured to accommodate the powder material from the powder supply device, and provide a space for printing the powder material into a workpiece; an energy source, configured to selectively apply an energy beam to the powder material in the forming device to print the powder material; and a Coulomb force application device, configured to apply a Coulomb force to the powder material in the forming device in a predetermined direction.

According to an aspect of the present application, the Coulomb force application device includes a power supply and an electric field generation device, wherein, the power supply is connected to the forming device to charge the powder material in the forming device, and the electric field generation device includes a first electrode plate and a second electrode plate which are opposite to each other and have opposite polarities, to generate an electric field between the first electrode plate and the second electrode plate.

According to an aspect of the present application, the first electrode plate and the second electrode plate extend in a vertical direction and are spaced apart in a horizontal direction, so that the Coulomb force application device applies a Coulomb force to the powder material in the horizontal direction.

According to an aspect of the present application, the forming device is arranged between the first electrode plate and the second electrode plate, and a height of the first electrode plate and the second electrode plate in the vertical direction is larger than a height of the forming device in the vertical direction.

According to an aspect of the present application, the additive manufacturing system further includes a controller which is configured to control the Coulomb force application device according to a forming direction of a region to be formed based on a model of the workpiece.

According to an aspect of the present application, the controller is configured to set the region to be formed as a sagging area and control the Coulomb force application device to apply the Coulomb force to the powder material in a case that a forming angle between the forming direction of the region to be formed and a vertical direction is less than a preset angle threshold, so that an angle between a direction of a resultant force of the gravity and the Coulomb force on the powder material, and the forming direction is greater than the angle threshold.

According to an aspect of the present application, the controller is configured to apply a Coulomb force that increases layer by layer to the powder material during continuous printing of a plurality layers before a first layer of the sagging area and the first layer, wherein, the Coulomb force with a maximum value is a first Coulomb force.

According to an aspect of the present application, the controller is configured to uniformly apply the first Coulomb force to the powder material during printing the sagging area.

According to an aspect of the present application, the additive manufacturing system further includes a thickness detector configured to detect deposition thicknesses of multiple positions, spaced apart in the horizontal direction, of the powder material for the workpiece, and the controller is configured to adjust an energy magnitude of the energy beam according to the detected deposition thicknesses.

According to an aspect of the present application, the first electrode plate and the second electrode plate extend in a horizontal direction and are spaced apart in a vertical direction, so that the Coulomb force application device applies a Coulomb force to the powder material in the vertical direction.

According to an aspect of the present application, the forming device is arranged between the first electrode plate and the second electrode plate, a length of the first electrode plate and the second electrode plate in the horizontal direction is larger than a length of the forming device in the horizontal direction.

According to an aspect of the present application, the electric field generation device further includes a third electrode plate and a fourth electrode plate which are opposite to each other and have opposite polarities, and the third electrode plate and the fourth electrode plate extend in the horizontal direction and are spaced apart in the vertical direction, so that the Coulomb force application device further applies a Coulomb force to the powder material in the vertical direction.

According to an aspect of the present application, the forming device includes a substrate which is configured to support the powder material accommodated in the forming device and is movable in the vertical direction, and the power supply is connected to the substrate.

According to another aspect of the present application, an additive manufacturing method is provided, which includes the following steps: supplying a powder material; applying a Coulomb force to the powder material; and printing the powder material with an energy beam.

According to another aspect of the present application, the step of applying a Coulomb force to the powder material includes: calculating a forming angle between a forming direction of a region to be formed of a workpiece and a vertical direction based on a model of the workpiece; comparing the forming angle with a preset angle threshold; setting the region to be formed with the forming angle less than the angle threshold as a sagging area; and applying the Coulomb force to the powder material and controlling the Coulomb force during printing the sagging area, so that an angle between a direction of a resultant force of the gravity and the Coulomb force on the powder material, and the forming direction is greater than the angle threshold.

According to another aspect of the present application, the step of applying a Coulomb force to the powder material includes: applying a Coulomb force that increases layer by layer to the powder material during continuous printing of multiple layers before a first layer of the sagging area and the first layer, wherein the Coulomb force with a maximum value is a first Coulomb force.

According to another aspect of the present application, the first Coulomb force is uniformly applied to the powder material during printing the sagging area.

According to another aspect of the present application, the additive manufacturing method further includes: detecting deposition thicknesses of multiple positions, spaced apart in the horizontal direction, of the powder material for the workpiece, and adjusting an energy magnitude of the energy beam according to the detected deposition thicknesses.

According to another aspect of the present application, the step of applying a Coulomb force to the powder material includes: applying a vertical downward Coulomb force to the powder material.

In the additive manufacturing system and method according to the present application, the Coulomb force can be selectively applied to the powder material by the Coulomb force application device to provide a controlled vector force, so that the additive manufacturing system and method are applicable to various use environments and/or processing workpieces with various complex structures, thereby improving the industrial applicability of the additive manufacturing system and method.

Other advantages and features of the present application will become clear in the following non-restrictive detailed description.

### BRIEF DESCRIPTION OF THE DRAWINGS

The features and advantages of one or more embodiments of the present application will become more readily understood from the following description with reference to the accompanying drawings in which:

FIG. 1 is a schematic cross-sectional view of an additive manufacturing system according to a first embodiment of the present application;

FIG. 2a is a schematic view of an end face of a workpiece printed by an existing additive manufacturing system; FIG. 2b is a schematic view of an end surface of a workpiece printed by the additive manufacturing system according to the first embodiment of the present application;

FIG. 3a to FIG. 3c are force analysis diagrams of powder particles used in different regions to be formed in the additive manufacturing system according to the first embodiment of the present application;

FIG. 4 is a schematic cross-sectional view of the additive manufacturing system according to a second embodiment of the present application;

FIG. 5 is a schematic cross-sectional view of the additive manufacturing system according to a third embodiment of the present application; and

FIG. 6a and FIG. 6b are flowcharts of an additive manufacturing method according to exemplary embodiments of the present application.

### DETAILED DESCRIPTION OF EMBODIMENTS

The present application is described in detail hereinafter by means of embodiments with reference to the accompanying drawings. The following detailed description of the present application is intended to illustrate the present application rather than limit the present application and applications or usages thereof. Corresponding reference numerals indicate corresponding components throughout the drawings.

Embodiments are provided herein such that the present application will be thorough, and will fully convey the scope of the present application to those skilled in the art. Examples of many specific details such as specific components, devices and methods are described to provide a thorough understanding of embodiments of the present application. It is apparent to those skilled in the art that, the embodiments may be implemented in many different forms without the specific details, and hence should not be construed as limiting the scope of the present application. In some embodiments, known methods, known devices, and known techniques are not described in detail.

Although the terms such as “first”, “second”, and “third” may be used herein to describe various elements, components, regions, layers and/or sections, these elements, components, regions, layers and/or sections should not be limited by these terms. These terms may be used only to distinguish one element, component, region, layer or section from another element, component, region, layer or section. Numerical terms such as “first” and “second” herein do not indicate an order or a sequence unless an order or a sequence is clearly indicated in the context. Thus, a first element, a first component, a first region, a first layer or a first section discussed below may be referred as a second element, a second component, a second region, a second layer or a second section without departing from the teachings of the embodiments.

The orientation words such as “up”, “down”, “left”, and “right” mentioned herein refer to orientations observed from the drawings, and the orientation words are used for easy of description and are not intended to limit the present application unless otherwise explicitly stated herein.

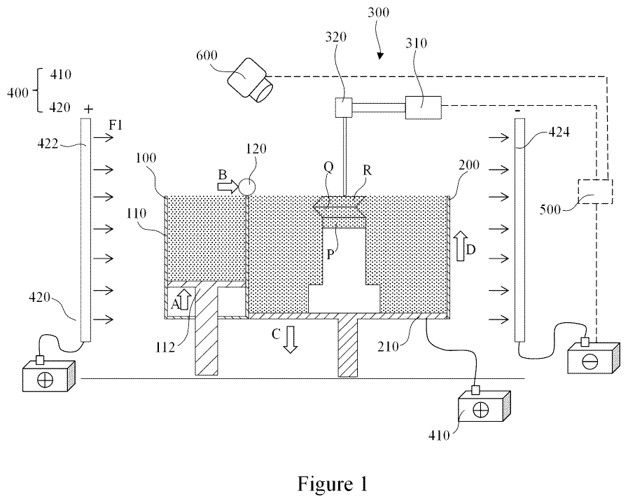

An additive manufacturing system 10 according to a first embodiment of the present application is described below with reference to FIG. 1. It should be understood that the additive manufacturing system 10 schematically shown in FIG. 1 is only for illustrative purpose, and is not intended to limit a structure of the additive manufacturing system according to the present application.

Referring to FIG. 1, the additive manufacturing system 10 may include a powder supply device 100, a forming device 200, an energy source 300, a Coulomb force application device 400 and a controller 500.

The powder supply device 100 is configured to supply a powder material to the forming device 200. Exemplarily, the powder material may include metal powders. As shown in FIG. 1, the powder supply device 100 includes a powder storage device 110 for storing the powder material and a conveying device 120 for conveying the powder material from the powder storage device 110 to the forming device 200. The powder storage device 110 includes a piston rod 112 configured to be movable up and down. The conveying device 120 includes a conveying roller which is movable in a horizontal direction.

When the powder material needs to be supplied, first, the piston rod 112 of the powder storage device 110 moves upward in a direction indicated by an arrow A in FIG. 1, so that the powder material protrudes from an upper edge of the powder storage device 110. Then, the conveying device 120 moves from an end (the left end in FIG. 1) of the powder storage device 110 to another end (the right end in FIG. 1) of the forming device 200 in a direction indicated by an arrow B, so as to convey the powder material at the top of the powder storage device 110 to the forming device 200. Thereafter, the conveying device 120 returns from the another end (the right end in FIG. 1) of the forming device 200 to the end (the left end in FIG. 1) of the powder storage device 110 in a direction opposite to the arrow B, so that the powder material is uniformly laid on the top of the forming device 200.

It should be understood that the construction of the powder supply device 100 is not limited to the example shown in FIG. 1, and may be changed as long as it can realize the function described herein. For example, the powder supply device may further include a powder supply funnel arranged above the forming device 200, so as to uniformly spray the powder material into the forming device.

After the conveyed powder material reaches a predetermined thickness, the energy source 300 selectively applies an energy beam to the powder material in the forming device 200 according to a model of a workpiece, so that the powder material is melted and then solidified to print and form the layer of the workpiece. In the example shown in FIG. 1, the energy source 300 includes a laser 310 and a light shaping device 320. The laser 310 is configured to emit a laser beam, and the light shaping device 320 is configured to shape the laser beam. The laser beam shaped by the light shaping device 320 has desired optical characteristics, spot size or shape, and the like. It should be understood that the energy source should not be limited to the example shown in FIG. 1, and may be changed as long as it can realize the function described herein. For example, the energy source may be an energy source that generates an electron beam, and a plasma beam or an ion beam.

The forming device 200 is configured to accommodate the powder material from the powder supply device 100, and provide a space for printing the powder material into a workpiece. The forming device 200 includes a substrate 210 which is configured to support the powder material accommodated in the forming device 200 and is movable in a vertical direction. The substrate 210 may move downwards along the vertical direction indicated by an arrow C in FIG. 1 after a layer of the workpiece is formed by printing. For example, the substrate 210 moves downwards by a height corresponding to a thickness of a next to-be-printed layer of the workpiece. Then, the powder supply device 100 conveys the powder material to the top of the forming device 200 again, and then repeats the above forming process to print the next layer of the formed workpiece. As the workpiece is formed layer by layer, the piston rod 112 of the powder supply device 100 moves upward in the direction indicated by the arrow A, the substrate 210 of the forming device 200 moves downward in the direction indicated by the arrow C, and the workpiece is manufactured layer by layer in the upward direction indicated by an arrow D.

The Coulomb force application device 400 is configured to apply a Coulomb force to the powder material in a forming cavity 200 in a predetermined direction. The Coulomb force application device 400 includes a power supply 410 and an electric field generation device 420. The power supply 410 is connected to the forming device 200 to charge the powder material in a forming cavity. FIG. 1 exemplarily represents that the powder material is charged with positive polarity by the power supply 410. Preferably, the power supply 410 may be connected to the substrate 210 of the forming device 200, so that the power supply 410 can always provide a sufficient charge conduction area during the substrate 210 moves up and down. The electric field generation device 420 includes a first electrode plate 422 and a second electrode plate 424 which are opposite to each other and have opposite polarities, to generate an electric field between the first electrode plate 422 and the second electrode plate 424. Exemplarily, as shown in FIG. 1, the first electrode plate 422 and the second electrode plate 424 may have positive polarity and negative polarity, respectively, by being connected to an external power supply respectively.

As exemplarily shown in FIG. 1, the first electrode plate 422 and the second electrode plate 424 may extend in the vertical direction and are spaced apart in the horizontal direction, so as to apply a Coulomb force F1 to the powder material in the horizontal direction. Preferably, as shown in FIG. 1, the forming device 200 is arranged between the first electrode plate 422 and the second electrode plate 424, and a height of the first electrode plate 422 and the second electrode plate 424 in the vertical direction is larger than a height of the forming device 200 in the vertical direction, so that the powder material in the entire forming device 200 is subjected to the uniform Coulomb force.

In the existing additive manufacturing process, if a forming angle between a forming direction of a to-be-processed region of the workpiece and the vertical direction is less than 135 degrees (that is, an inclination angle between the forming direction and the horizontal direction is less than 45 degrees), the solid powder material in the lower layer cannot provide sufficient supporting force for the heated and melted powder droplets, which leads to easy sagging or deformation of the processed workpiece, thereby seriously affecting the quality of the processed workpiece. Therefore, the principle of 45-degree-angle is well known in additive manufacturing technology. Once the inclination angle is less than 45 degrees, it is necessary to add a supporting structure for the workpiece during additive manufacturing, otherwise the workpiece will be deformed or even unable to be formed by printing normally.

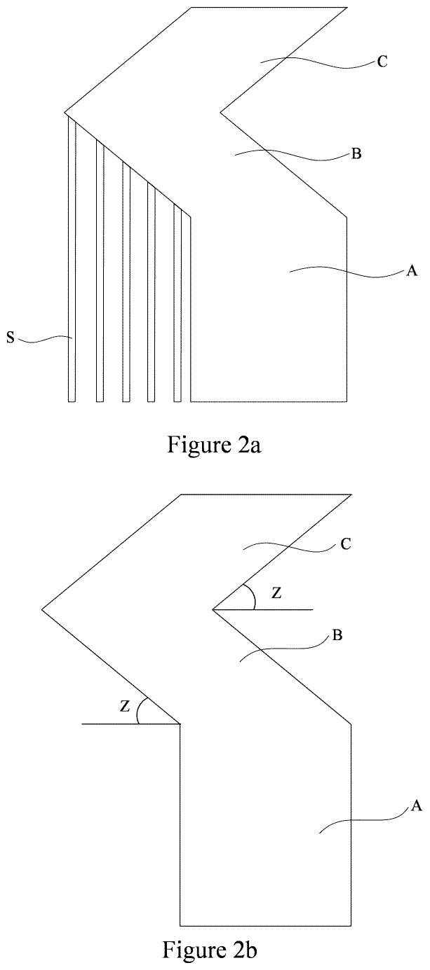

FIG. 2a is a schematic view of an end face of a workpiece printed by the existing additive manufacturing system; FIG. 2b is a schematic view of an end surface of a workpiece printed by the additive manufacturing system according to the first embodiment of the present application. As shown in FIGS. 2a and 2b, the workpiece includes a first forming region A, a second forming region B and a third forming region C. An inclination angle Z between the second forming region B and the horizontal direction and that between the third forming region C and the horizontal direction are less than 45 degrees. When the two regions are printed, the supporting structures S need to be printed simultaneously to support the powder material, otherwise, the powder material of the hanging portion will drop under the gravity during the printing process, resulting in quality defects. However, the supporting structures deteriorate the surface quality of the workpiece, and removal of the supporting structure requires a complicated post-treatment process. In addition, printing this supporting structure further causes consumption of raw materials, printing time and energy. Therefore, the supporting structure is considered to be a technical problem that is hard to overcome in additive manufacturing.

In contrast, referring to FIG. 2b, by using the additive manufacturing system according to the first embodiment of the present application, the second forming region B and the third forming region C can be printed without using a supporting structure, and a Coulomb force is applied to the powder material by the Coulomb force application device 400 to provide a controlled vector force, so that the second forming region B and the third forming region C can be printed and manufactured without support. Specifically, the Coulomb force in the horizontal direction can be applied to the powder particles by the Coulomb force application device 400, so that the powder particles are subjected to a resultant force of the horizontal Coulomb force and gravity, and an angle between a direction of the resultant force on the powder particle and the forming direction is greater than a preset angle threshold.

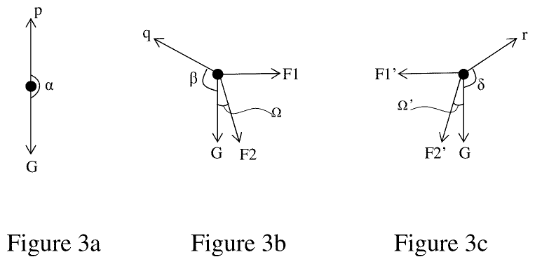

Preferably, the additive manufacturing system 10 may further include a controller 500, which is connected to the Coulomb force application device 400, of course, the controller 500 may communicates with the Coulomb force application device 400 via a wireless manner. The controller 500 is configured to determine a forming direction of a region to be formed of the workpiece based on a model of the workpiece and control the Coulomb force application device 400 according to the forming direction. As shown in FIG. 1, the workpiece includes a first region to be formed P, a second region to be formed Q and a third region to be formed R. Referring to FIG. 1 and FIG. 3a to FIG. 3c, the first region to be formed P has a first forming direction indicated by an arrow p, and the controller 500 can determine that a first forming angle α between the first forming direction and the gravity direction is 180 degrees based on the model of the workpiece. The second region to be formed Q has a second forming direction indicated by an arrow q, and the controller 500 can determine that a second forming angle β between the second forming direction and the gravity direction is 130 degrees based on the model of the workpiece. The third region to be formed R has a third forming direction indicated by an arrow r, and the controller 500 can determine that a third forming angle δ between the third forming direction and the gravity direction is 130 degrees based on the model of the workpiece.

Further, the controller 500 is configured to set the region to be formed as a sagging area and turn on the Coulomb force application device 400 when the forming angle is less than the preset angle threshold. The preset angle threshold can be, for example, 135 degrees. Certainly, the angle threshold may be changed within a certain range according to factors such as the type of powder material.

Specifically, the controller 500 determines that the first forming angle α is greater than the angle threshold of 135 degrees, and the first region to be formed P is processed without turning on the Coulomb force application device. In addition, the controller determines that the second forming angle β and the third forming angle δ are less than the angle threshold of 135 degrees. Therefore, the second region to be formed Q and the third region to be formed R are set as sagging areas and the Coulomb force application device is turned on to process the second region to be formed Q and the third region to be formed R.

Therefore, when the second region to be formed Q and the third region to be formed R are processed, the Coulomb force application device 400 is in use. In this case, the power supply 410 charges the powder material in the forming cavity 200 through the substrate 210. Further, the Coulomb force application device 420 applies a Coulomb force to the charged powder material in the horizontal direction. Thus, the powder material is subjected to the resultant force of the horizontal Coulomb force F1 and the vertical downward gravity G.

Moreover, the controller 500 controls the horizontal Coulomb force applied by the Coulomb force application device 400, so that the angle between the direction of the resultant force on the powder material and the forming direction is greater than the preset angle threshold, for example, 135 degrees.

FIG. 3b exemplarily shows that the second forming direction indicated by the arrow q may be inclined to the left. In this case, the first electrode plate 422 on the left side may have positive polarity and the second electrode plate 424 on the right side may have negative polarity, so as to apply a horizontal Coulomb force F1 to the powder material toward the right. The horizontal Coulomb force F1 deflects the direction of the resultant force F2 on the powder material to the right by an angle Ω relative to the gravity direction. Field strength of the Coulomb force application device 400 is adjusted, so that a sum of the second forming angle β and the deflection angle Ω is greater than 135 degrees. FIG. 3 further exemplarily shows that the third forming direction indicated by the arrow r can be inclined to the right. Therefore, when the third region to be formed R is processed, the polarities of the two electrode plates can be interchanged, so that the first electrode plate 422 on the left side has negative polarity and the second electrode plate 424 on the right side has positive polarity, so as to apply a horizontal Coulomb force F1′ to the powder material toward the left. The horizontal Coulomb force F1′ deflects the direction of the resultant force F2′ on the powder material to the left by an angle Ω′ relative to the gravity direction, and the field strength of the Coulomb force application device 400 is adjusted, so that the sum of the third forming angle δ and the deflection angle Ω′ is greater than 135 degrees. In this way, even during printing the sagging area for which the supporting structure has to be used in the conventional technology, the heated and melted powder droplets can be stably supported on the solid powder particles in the lower layer, and are supported by the powder material itself without using an additional supporting structure, so that more complicated workpieces can be processed by additive manufacturing, thereby significantly reducing the manufacturing cost, and improving the manufacturing efficiency and the quality of the workpiece.

The additive manufacturing system according to the first embodiment of the present application can print and manufacture a workpiece with a hanging structure without support, and even print and manufacture a hanging structure with an inclination angle of substantially 0°. This unsupported additive manufacturing technology can overcome the limitations of principle of the 45-degree-angle, improve the design freedom of metal additive manufacturing, allow a designer to more freely construct a processing model, print and manufacture a workpiece with more complex structure, and improve the industrial applicability of the additive manufacturing system. In addition, the unsupported additive manufacturing technology further shortens processing time, reduces processing costs, and improves the forming quality of the workpiece.

Although FIG. 1 exemplarily shows that the Coulomb force application device 400 includes the first electrode plate 422 and the second electrode plate 424 extending in the vertical direction, it should be understood that the Coulomb force application device 400 is not limited to the specific example shown in FIG. 1, but can be changed, as long as the Coulomb force application device 400 could adjust the angle between the direction of the resultant force on the powder material and the forming direction greater than the angle threshold. For example, the first electrode plate 422 and the second electrode plate 424 may be inclined by a certain angle relative to the vertical direction. Preferably, the Coulomb force application device 400 as shown in FIG. 1 is used, which can manufacture a hanging structure with a wider angle range and even manufacture a hanging structure with an inclination angle of substantially 0°.

In addition, although controlling the Coulomb force application device by the controller 500 has been exemplarily described above, it should be understood that the present application is not limited thereto, the controller 500 could be omitted and a switch of the Coulomb force application device which is manually operated could be provided. For example, the required maximum Coulomb force may be calculated in advance and the switch may be manually turned on by the operator according to whether the printed workpiece is in the sagging area, so as to apply the Coulomb force by the Coulomb force application device for processing the workpiece.

In addition, preferably, the controller 500 is further configured to apply a Coulomb force that increases layer by layer to the powder material by using the Coulomb force application device 400 during a predetermined time period. The predetermined time period corresponds to a time for continuous printing of multiple layers before a first layer of the second region to be formed Q and the first layer.

Referring to FIG. 1, according to the model of the workpiece, the second region to be formed Q is set as a sagging area and the first region to be formed P needs to be printed before the second region to be formed Q is printed. Exemplarily, during printing nine layers before printing the first layer of the second region to be formed Q (i.e., the last layer to the ninth to last layer of the first region to be formed P) and the first layer of the second region to be formed Q, an electric field that increases layer by layer is applied to the powder material by the Coulomb force application device 400. Specifically, as shown in Table 1 below (in Table 1, the first region to be formed P and the second region to be formed Q are referred to as P and Q, respectively), when the ninth to last layer of the first region to be formed P is printed, the applied electric field strength is 5 N/C, and the resultant direction of the horizontal Coulomb force and gravity on the powder particle is deflected by 1 degree relative to the vertical direction. When the eighth to last layer of the first region to be formed P is printed, the applied electric field strength is 10 N/C, and the resultant direction of the horizontal Coulomb force and gravity on the powder particle is deflected by 2 degrees relative to the vertical direction. In this way, when the last layer of the first region to be formed P is printed, the applied electric field strength is 45 N/C, and the resultant direction of the horizontal Coulomb force and gravity on the powder particle is deflected by 9 degrees relative to the vertical direction. When the first layer of the second region to be formed Q is printed, the applied electric field strength is 50 N/C, the resultant direction of the horizontal Coulomb force and gravity on the powder particle is deflected by 10 degrees relative to the vertical direction, and during the printing of other layers of the second region to be formed Q, the electric field strength is maintained to apply a uniform Coulomb force to the powder material. Therefore, during the printing of the entire second forming region Q, the angle between the direction of the resultant force on the powder material and the forming direction is increased by 10 degrees from the original 130 degrees and then maintained at 140 degrees, which is greater than the threshold angle of 135 degrees.

TABLE 1
Coulomb force for different layers

| | | | Charge | Electric |
|---|---|---|---|---|
| | Deflection | | quantity of | field |
| | angle | Coulomb | a particle | strength |
| Number of layers | (°) | force(N) | (C) | (N/C) |
| Ninth to last layer of | 1 | 2.7E⁻⁷ | 4.17E⁻⁸ | 5 |
| P | | | | |
| Eighth to last layer of | 2 | 4.14E⁻⁷ | 4.17E⁻⁸ | 10 |
| P | | | | |
| Seventh to last layer | 3 | 6.21E⁻⁷ | 4.17E⁻⁸ | 15 |
| of P | | | | |
| Sixth to last layer of | 4 | 8.28E⁻⁷ | 4.17E⁻⁸ | 20 |
| P | | | | |
| Fifth to last layer of | 5 | 1.04E⁻⁶ | 4.17E⁻⁸ | 25 |
| P | | | | |
| Fourth to last layer of | 6 | 1.24E⁻⁶ | 4.17E⁻⁸ | 30 |
| P | | | | |
| Third to last layer of | 7 | 1.45E⁻⁶ | 4.17E⁻⁸ | 35 |
| P | | | | |
| Second to last layer | 8 | 1.66E⁻⁶ | 4.17E⁻⁸ | 40 |
| of P | | | | |
| Last layer of P | 9 | 1.88E⁻⁶ | 4.17E⁻⁸ | 45 |
| First layer of Q | 10 | 2.09E⁻⁶ | 4.17E⁻⁸ | 50 |

In this way, by gradually applying the Coulomb force that increases layer by layer, it is possible to prevent the powder material from apparently moving horizontally when the powder material is suddenly subjected to the sharply increased Coulomb force, so that the forming quality of the workpiece by additive manufacturing can be improved.

Preferably, the additive manufacturing system 10 further includes a thickness detector 600. The controller 500 is connected to the thickness detector and the energy source or communicates with the thickness detector and the energy source wirelessly. Exemplarily, the thickness detector 600 may include TOF camera, the deposition thicknesses of multiple positions of the powder material could be obtained by the TOF camera. The thickness detector 600 is configured to detect deposition thicknesses of multiple positions, spaced apart in the horizontal direction, of the powder material for forming the workpiece in the forming device 200, and the controller 500 is configured to adjust an energy magnitude of the energy beam according to the detected deposition thicknesses. For example, when the first layer of the second region to be formed Q is printed, the multiple positions of the powder material for forming the first layer in the forming device 200 are detected to obtain the deposition thicknesses of the powder material at different positions of the first layer. The controller 500 is configured to control the energy source to emit a larger energy beam to a thicker region and a smaller energy beam to a thinner region according to the deposition thicknesses.

In this way, even if the powder material undergoes some displacement under the action of the horizontal Coulomb force, and the deposition thicknesses of the same layer are not uniform, and the non-uniform deposited layer can be adapted by applying an adjustable energy beam.

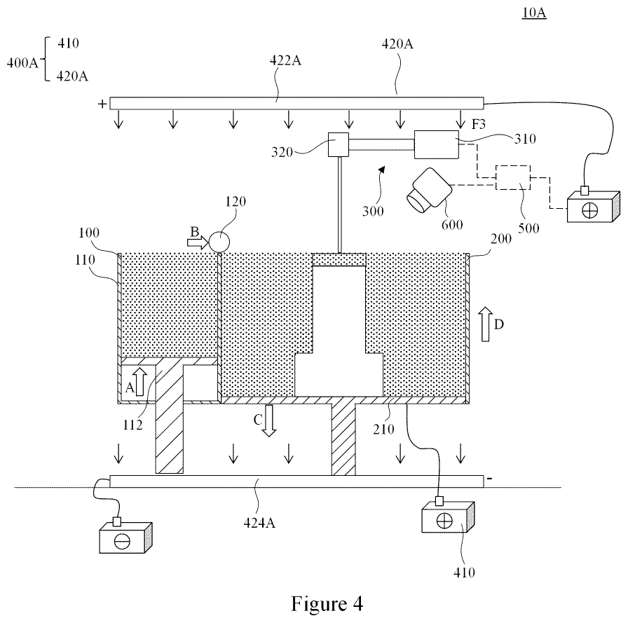

The additive manufacturing system according to a second embodiment of the present application will be described in detail with reference to FIG. 4. The structure of the additive manufacturing system 10A of the second embodiment of the present application is substantially the same as the structure of the additive manufacturing system 10 according to the first embodiment of the present application, and the only difference is the arrangement of the Coulomb force application device.

As shown in FIG. 4, the electric field generation device 420A of the additive manufacturing system 10A includes a first electrode plate 422A and a second electrode plate 424A which are opposite to each other and have opposite polarities, the first electrode plate 422A and the second electrode plate 424A extend in a horizontal direction and are spaced apart in a vertical direction, so as to apply a Coulomb force F3 in the vertical direction to the powder material. Preferably, the forming device 200 is arranged between the first electrode plate 422A and the second electrode plate 424A, and a length of the first electrode plate 422A and the second electrode plate 424A in the horizontal direction is larger than a length of the forming device 200 in the horizontal direction, so that the entire forming device 200 is subjected to the uniform Coulomb force.

In reduced gravity environments, the Coulomb force application device 400A of the additive manufacturing system 10A charges the powder material by the power supply 410. The electric field generation device 420A applies a vertical downward Coulomb force F3 to the charged powder material, and the later-formed material layer is deposited on the previously-formed material layer under the action of this Coulomb force, thereby manufacturing the required workpiece layer by layer.

The additive manufacturing system according to the second embodiment of the application can overcome the problem that the existing additive manufacturing system cannot work in reduced gravity environments, thereby broadening the application scenarios of the additive manufacturing system, and improving the industrial applicability of the additive manufacturing system.

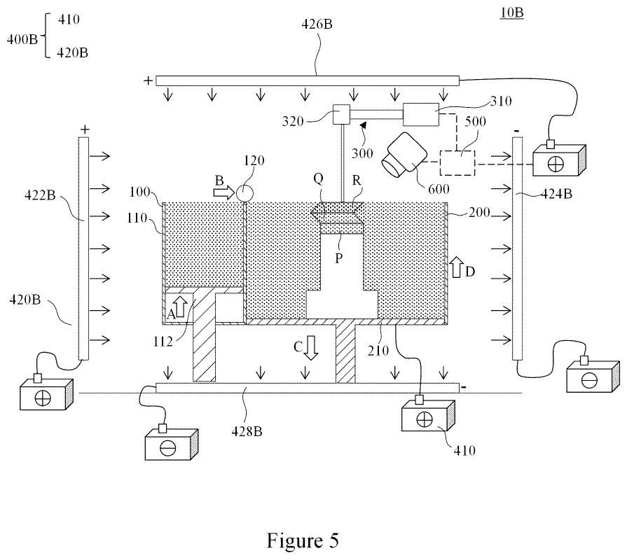

The additive manufacturing system according to a third embodiment of the present application will be described in detail with reference to FIG. 5. The structure of the additive manufacturing system 10B of the third embodiment of the present application is substantially the same as the structure of the additive manufacturing system 10 according to the first embodiment of the present application, and the only difference is the arrangement of the Coulomb force application device.

As shown in FIG. 5, the Coulomb force application device 420B of the additive manufacturing system 10B may include two sets of electrode plates. The first set of electrode plates includes a first electrode plate 422B and a second electrode plate 424B which are opposite to each other and have opposite polarities, the first electrode plate 422B and the second electrode plate 424B extend in a vertical direction and are spaced apart in a horizontal direction, so as to apply a Coulomb force in the horizontal direction to the powder material. The second set of electrode plates includes a third electrode plate 426B and a fourth electrode plate 428B which are opposite to each other and have opposite polarities, the third electrode plate 426B and the fourth electrode plate 428B extend in the horizontal direction and are spaced apart in the vertical direction, so as to apply a Coulomb force in the vertical direction to the powder material.

The additive manufacturing system 10B according to the third embodiment of the present application simultaneously has the functions of both the additive manufacturing system 10 according to the first embodiment of the present application and the additive manufacturing system 10A according to the second embodiment of the present application. That is, the additive manufacturing system 10B can choose different use modes according to the use conditions, so that it can print and manufacture a workpiece with a hanging structure without support, and even print and manufacture a hanging structure with an inclination angle of substantially 0°, and realize additive manufacturing in reduced gravity environments, thereby further improving the industrial applicability of the additive manufacturing system.

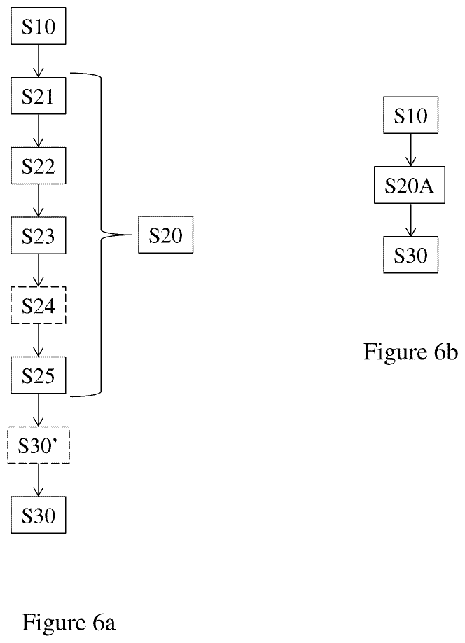

An additive manufacturing method according to embodiments of the present application is described below with reference to FIG. 6a and FIG. 6b.

Referring to FIG. 6, the additive manufacturing method includes the following steps: supplying a powder material into a forming device (step S10); applying a Coulomb force to the powder material by a Coulomb force application device (step S20); and printing the powder material with an energy beam (S30).

In a preferred embodiment, the step S20 includes: calculating a forming angle between a forming direction of a region to be formed of a workpiece and a vertical direction based on a model of the workpiece (step S21); comparing the forming angle with a preset angle threshold (step S22); setting the region to be formed with the forming angle less than the angle threshold as a sagging area (step S23); and applying the Coulomb force to the powder material and controlling the Coulomb force during printing the sagging area, so that an angle between a direction of a resultant force of the gravity and the Coulomb force on the powder material, and the forming direction is greater than the angle threshold (step S25).

Preferably, the step S20 further includes step S24: applying a Coulomb force that increases layer by layer to the powder material during continuous printing of multiple layers before a first layer of the sagging area and the first layer (S24), wherein the Coulomb force with a maximum value is a first Coulomb force. In addition, the first Coulomb force is uniformly applied to the powder material during printing the sagging area.

Preferably, the step S20 further includes step S30′: detecting deposition thicknesses multiple positions, spaced apart in a horizontal direction, of the powder material for the workpiece, and adjusting an energy magnitude of the energy beam according to the detected deposition thicknesses.

In another embodiment, referring to FIG. 6b, the additive manufacturing method includes the following steps: supplying a powder material into a forming device 200 (step S10); applying a vertical downward Coulomb force to the powder material by a Coulomb force application device (step S20A); and printing the powder material with an energy beam (S30).

It should be understood that the additive manufacturing method according to the present application is not limited to the examples described herein or shown in the drawings, and may be changed. For example, a step may be added or omitted, and an order of the steps may be changed, according to practical needs.

### First Embodiment

A titanium alloy TC4 with a diameter ranging from 20 to 80 μm (with an average diameter of 50 μm) and a density of 4.51 g/cm³ is used as a powder material, and it is used to manufacture the second region to be formed Q of the workpiece in the additive manufacturing system according to the first embodiment of the present application. The mass m of the heavier TC4 powder particles with a diameter of 80 μm is 1.21*10⁻⁶ kg. Assuming that g is 9.8 N/kg and the deflection angle Ω is 10 degrees, the Coulomb force F1 is calculated from m*g* tan Ω and is equal to 2.09*10⁻⁶n. If the field strength E1 of the applied uniform electric field is 50 N/C, the charged quantity of each powder particle is 4.17*10⁻⁸C. Assuming that the total volume of the powder material accommodated in the forming device is 40 cm*40 cm*20 cm, the charged quantity of each powder particle is 4.17*10⁻⁸C, so the total power required for charging the powder material is substantially 21000C (substantially 1.3 kWh).

### Second Embodiment

A titanium alloy TC4 with a diameter ranging from 20 to 80 μm (with an average diameter of 50 μm) and a density of 4.51 g/cm³ is used as a powder material, and it is used to manufacture the workpiece in the additive manufacturing system according to the second embodiment of the present application. For a gravity free environment, the powder material can be stacked layer by layer normally when the powder material is subjected to substantially 1/10 of the magnitude of gravity. Therefore, the required Coulomb force F2 for the powder material is 10%*m*g. In a uniform electric field with the field strength E2 of 50 N/C, the charged quantity Q of the TC4 powder particle with a diameter of 80 μm is 2.4*10⁻⁸C. Assuming that the total volume of the powder material accommodated in the forming device is 40 cm*40 cm*20 cm, the charged quantity of each powder particle is 2.4*10⁻⁸C, so the total power required for charging the powder material is substantially 11600C (substantially 0.7 kWh).

According to the above embodiments, it can be seen that the additive manufacturing system and method according to the present application can be applicable to various use environments and/or processing the workpieces with various complex structures with very little power consumption and processing cost, thereby improving the industrial applicability of the additive manufacturing system and method.

Although the present application has been described with reference to the embodiments, it will be appreciated that the present application is not limited to the specific embodiments described and illustrated in detail herein. The person skilled in the art can make various variants to the embodiments without departing from the scope defined by the claims.

1. An additive manufacturing system, comprising:
a powder supply device, configured to supply a powder material;
a forming device, configured to accommodate the powder material from the powder supply device, and provide a space for printing the powder material into a workpiece;
an energy source, configured to selectively apply an energy beam to the powder material in the forming device to print the powder material; and
a Coulomb force application device, configured to apply a Coulomb force to the powder material in the forming device in a predetermined direction.

2. The additive manufacturing system according to claim 1, wherein the Coulomb force application device comprises a power supply and an electric field generation device, wherein the power supply is connected to the forming device to charge the powder material in the forming device, and the electric field generation device comprises a first electrode plate and a second electrode plate which are opposite to each other and have opposite polarities, to generate an electric field between the first electrode plate and the second electrode plate.

3. The additive manufacturing system according to claim 2, wherein the first electrode plate and the second electrode plate extend in a vertical direction and are spaced apart in a horizontal direction, so that the Coulomb force application device applies a Coulomb force to the powder material in the horizontal direction.

4. The additive manufacturing system according to claim 3, wherein the forming device is arranged between the first electrode plate and the second electrode plate, and a height of the first electrode plate and the second electrode plate in the vertical direction is larger than a height of the forming device in the vertical direction.

5. The additive manufacturing system according to claim 1, wherein the additive manufacturing system further comprises a controller which is configured to control the Coulomb force application device according to a forming direction of a region to be formed (P, Q, R) based on a model of the workpiece.

6. The additive manufacturing system according to claim 5, wherein the controller is configured to set the region to be formed as a sagging area and control the Coulomb force application device to apply the Coulomb force to the powder material in a case that a forming angle (β, δ) between the forming direction (q, r) of the region to be formed (Q, R) and a vertical direction is less than a preset angle threshold, so that an angle between a direction of a resultant force of the gravity and the Coulomb force (F2, F2′) on the powder material, and the forming direction (q, r) is greater than the angle threshold.

7. The additive manufacturing system according to claim 6, wherein the controller is configured to apply a Coulomb force that increases layer by layer to the powder material during continuous printing of a plurality of layers before a first layer of the sagging area and the first layer, wherein the Coulomb force with a maximum value is a first Coulomb force.

8. The additive manufacturing system according to claim 7, wherein the controller is configured to uniformly apply the first Coulomb force to the powder material during printing the sagging area.

9. The additive manufacturing system according to claim 5, wherein the additive manufacturing system further comprises a thickness detector configured to detect deposition thicknesses of a plurality of positions, spaced apart in a horizontal direction, of the powder material for the workpiece, and the controller is configured to adjust an energy magnitude of the energy beam according to the detected deposition thicknesses.

10. The additive manufacturing system according to claim 2, wherein the first electrode plate and the second electrode plate extend in a horizontal direction and are spaced apart in a vertical direction, so that the Coulomb force application device applies a Coulomb force to the powder material in the vertical direction.

11. The additive manufacturing system according to claim 10, wherein the forming device is arranged between the first electrode plate and the second electrode plate, a length of the first electrode plate and the second electrode plate in the horizontal direction is larger than a length of the forming device in the horizontal direction.

12. The additive manufacturing system according to claim 3, wherein the electric field generation device further comprises a third electrode plate and a fourth electrode plate which are opposite to each other and have opposite polarities, and the third electrode plate and the fourth electrode plate extend in the horizontal direction and are spaced apart in the vertical direction, so that the Coulomb force application device further applies a Coulomb force to the powder material in the vertical direction.

13. The additive manufacturing system according to claim 2, wherein the forming device comprises a substrate which is configured to support the powder material accommodated in the forming device and is movable in the vertical direction, and the power supply is connected to the substrate.

14. An additive manufacturing method, comprising the following steps:
supplying a powder material;
applying a Coulomb force to the powder material; and
printing the powder material with an energy beam.

15. The additive manufacturing method according to claim 14, wherein the step of applying a Coulomb force to the powder material comprises:
calculating a forming angle between a forming direction of a region to be formed of a workpiece and a vertical direction based on a model of the workpiece;
comparing the forming angle with a preset angle threshold;
setting the region to be formed (Q, R) with the forming angle less than the angle threshold as a sagging area; and
applying the Coulomb force to the powder material and controlling the Coulomb force during printing the sagging area, so that an angle between a direction of a resultant force of the gravity and the Coulomb force on the powder material, and the forming direction is greater than the angle threshold.

16. The additive manufacturing method according to claim 15, wherein the step of applying a Coulomb force to the powder material comprises:
applying a Coulomb force that increases layer by layer to the powder material during continuous printing of a plurality of layers before a first layer of the sagging area and the first layer, wherein the Coulomb force with a maximum value is a first Coulomb force.

17. The additive manufacturing method according to claim 16, wherein the first Coulomb force is uniformly applied to the powder material during printing the sagging area.

18. The additive manufacturing method according to claim 15, further comprising:
detecting deposition thicknesses of a plurality of positions, spaced apart in a horizontal direction, of the powder material for the workpiece, and adjusting an energy magnitude of the energy beam according to the detected deposition thicknesses.

19. The additive manufacturing method according to claim 14, wherein,
the step of applying a Coulomb force to the powder material comprises: applying a vertical downward Coulomb force to the powder material.
